(19) United States
(12) Patent Application Publication
(10) Pub. No.: US 2020/0180493 A1
(43) Pub. Date: Jun. 11, 2020

(54) AUTOMATED FILL SYSTEM

(71) Applicant: CNH Industrial Canada, Ltd., Saskatoon (CA)

(72) Inventor: Dennis George Thompson, Saskatoon (CA)

(73) Assignee: CNH Industrial Canada, Ltd.

(21) Appl. No.: 16/216,614

(22) Filed: Dec. 11, 2018

(51) Int. Cl. B60P 1/42; B65G 67/04; B65G 67/24; B65G 65/32; B65G 65/46; A01B 69/04

(52) U.S. Cl. CPC B60P 1/42; B65G 67/04; B65G 67/24; G05D 2201/0201; B65G 65/46; A01B 69/008; B65G 65/32

(57) ABSTRACT

An agricultural system that includes an automated fill system that delivers product to or removes product from a first storage tank automatically. The automated fill system includes a product conveyor system that transfers the product. The system includes an alignment system that aligns the product conveyer system to deliver or remove the product from the first storage tank. A controller controls the alignment system to control transfer of the product to and from the first storage tank.

### BACKGROUND

The invention relates generally to agricultural systems.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Generally, seeding implements are towed behind a tractor or other work vehicle. These seeding implements typically include one or more ground engaging tools or openers that form a trench for seed deposition into the soil. The openers are used to break the soil to enable seed deposition. After the seeds are deposited, each opener is followed by a packer wheel that packs soil on top of the deposited seeds. In certain configurations, an air cart is used to meter and deliver agricultural product (e.g., seeds, fertilizer, etc.) to ground engaging tools within the seeding implement. Certain air carts include a metering system and an air conveyance system configured to deliver metered quantities of product into an airflow that transfers the product to the openers. The air cart is periodically refilled from a product supply.

### BRIEF DESCRIPTION

In one embodiment, an agricultural system that includes a first storage tank that receives and stores product. The first storage tank includes a first lid that opens and closes a first aperture in the first storage tank. An automated fill system delivers product to or removes product from the first storage tank automatically. The automated fill system includes a product conveyor system that transfers the product. The product conveyer system includes a hopper that receives product from a second storage tank. A conveyor couples to the hopper and conveys the product away from the hopper. A spout couples to the conveyor and discharges the product driven by the conveyor. The system also includes an alignment system. The alignment system aligns the spout with the first aperture in the first storage tank. An opening system automatically opens the first lid to the first storage tank. The opening system includes a first actuator coupled to the first lid that opens and closes the first lid. A controller controls the alignment system and the opening system to control the transfer of the product from the second storage tank to the first storage tank.

In another embodiment, an agricultural system that includes an automated fill system that delivers product to or removes product from a first storage tank automatically. The automated fill system includes a product conveyer system that transfers the product. The system includes an alignment system that aligns the product conveyer system to deliver or remove the product from the first storage tank. A controller controls the alignment system to control transfer of the product to and from the first storage tank.

In a further embodiment, an agricultural system includes a first storage tank that receives and stores product. The first storage tank includes a first lid that opens and closes a first aperture in the first storage tank. An automated fill system delivers product to or removes product from the first storage tank automatically. The automated fill system includes a product conveyer system that transfers the product. The product conveyer system includes a hopper that receives product from a second storage tank. A conveyer couples to the hopper and conveys the product away from the hopper. A spout couples to the conveyer and discharges the product driven by the conveyer. The system includes an alignment system that aligns the spout with the first aperture in the first storage tank.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an agricultural system with an automated fill system;

FIG. 2 is a detailed perspective view of an embodiment of a position adjustment assembly that may be employed to adjust a position of a product conveyor system relative to the air cart of FIG. 1;

FIG. 3 is a top view of an embodiment of the agricultural system of FIG. 1 with the automated fill system maneuvering a product conveyer system to a first position;

FIG. 4 is a top view of an embodiment of the agricultural system of FIG. 1 with the automated fill system maneuvering a product conveyer system to a second position;

FIG. 5 is a top view of an embodiment of the agricultural system of FIG. 1 with the automated fill system maneuvering a product conveyer system to a third position; and

FIG. 6 is a top view of an embodiment of the agricultural system of FIG. 1 with the automated fill system maneuvering a product conveyer system to a fourth position.

### DETAILED DESCRIPTION

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

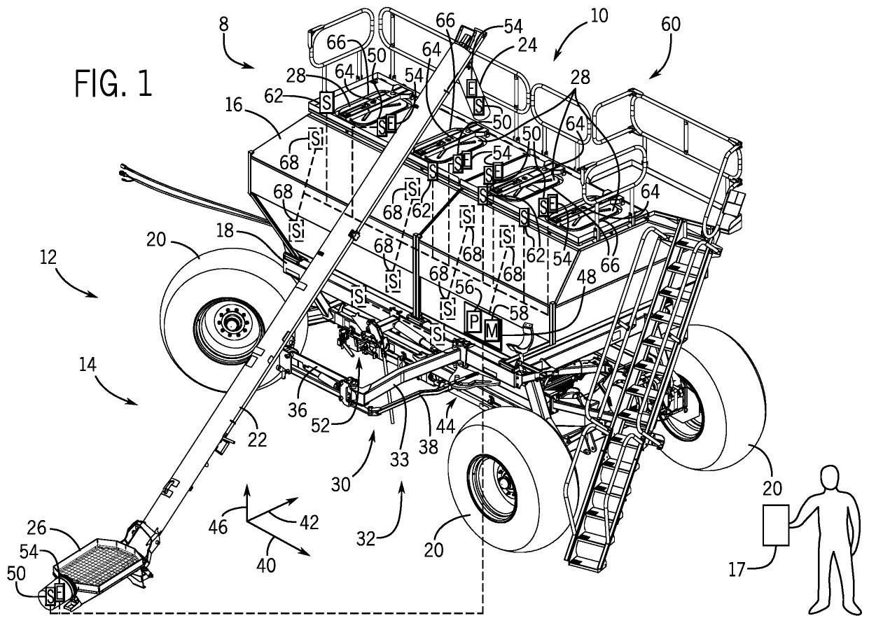

FIG. 1 is a perspective view of an agricultural system 8 including an agricultural storage system 10, such as the illustrated air cart. In order to facilitate filling, the agricultural system 8 includes an automated fill system 12 that automatically transfers product from a product source (e.g., a truck) to the air cart 10 or vice versa. That is, the process of filling the air cart 10 with product or removing excess unused product from the air cart 10 is controlled by the automated fill system 12 with little or no input from an operator. For example, the operator does not need to maneuver a product conveyor system 14 manually and/or use hydraulic input (i.e., levers). The operator may also not need to open lids to one or more storage compartments 16. The automated fill system 12 may therefore increase the efficiency of planting operations and reduce operator error involved in the transfer of product. In some embodiments, an operator may activate the automated fill system 12 with a handheld wireless device 17 (e.g., cellphone, laptop, tablet, handheld remote controller). The handheld wireless device 17 may also receive feedback regarding operation of the automated fill system 12. For example, the automated fill system 12 may indicate how much product is each of the storage compartments 16, estimated time to completion in refilling compartments 16, which storage compartment 16 is currently being refilled, etc. The handheld wireless device 17 may also provide input to the automated fill system 12. For example, the operator using the handheld wireless device 17 may indicate which compartment 16 is to receive which product, as well as with how much product.

The automated fill system 12 includes the product conveyor system 14 for moving product from an external source to the air cart 10. The air cart 10 includes one or more storage compartments 16 (e.g., holding containers), a frame 18, and wheels 20. The frame 18 includes a towing hitch configured to couple the air cart 10 to an implement or tow vehicle. In certain configurations, the storage compartments 16 may be used for storing various agricultural products. For example, one compartment may include seeds, and another compartment may include a dry fertilizer. In such configurations, the air cart 10 may be configured to deliver both the seeds and the fertilizer to an implement.

In certain embodiments, seeds and/or fertilizer within the storage compartments 16 are gravity fed into metering systems. The metering systems may include meter rollers to regulate the flow of product from the storage compartments 16 into an air flow provided by an air source. The air flow carries the product through one or more hoses or conduits to an implement, thereby supplying ground engaging tools of the implement with seeds and/or fertilizer for deposition into the soil.

In the illustrated embodiment, the product conveyor system 14 includes a product transporting tube 22, a guide tube 24 coupled to one end of the product transporting tube 22, and a hopper 26 coupled to the other end of the product transporting tube 22. The product conveyor system 14 is configured to move agricultural product from the hopper 26, through the product transporting tube 22 and guide tube 24, and into the storage compartments 16. As will be appreciated, the product may be introduced into the hopper 26 from a product transporting vehicle, such as an end-dump truck or a belly-dump truck.

During loading operations, a product transporting vehicle delivers the agricultural product into the hopper 26 (e.g., via an outlet in a bottom portion of a trailer). The hopper 26 then transfers the product to the product transporting tube 22. For example, an auger in the hopper 26 may rotate to move the product to the product transporting tube 22. The product transporting tube 22 may also include an auger configured to receive product from the hopper 26, and to move the product to the guide tube 24, which directs the product into the storage compartments 16. In certain embodiments, the transporting tube auger is coupled to the hopper auger such that rotation of the transporting tube auger drives the hopper auger to rotate. In alternative embodiments, the hopper 26 may include a belt system configured to transfer product from the hopper 26 to the product transporting tube 22. Further, the product transporting tube 22 may include another belt system that interfaces with the belt system of the hopper 26. The transporting tube belt system is configured to move the product from the hopper 26 to the guide tube 24, which directs the product into the storage compartments 16.

In the illustrated embodiment, the air cart 10 includes four storage compartments 16, each having an independent opening 28 for receiving product. In this configuration, the guide tube 24 of the product conveyor system 14 may be successively aligned with each opening 28 to facilitate product flow into the respective storage compartment 16. To facilitate movement of the product conveyor system 14 relative to the air cart 10, the agricultural system 8 includes a position adjustment assembly 30 and an alignment system 32.

In the illustrated embodiment, the position adjustment assembly 30 includes an inner arm 33, an outer arm 36, and an intermediate link 38. An actuator extending between the frame 18 of the air cart 10 and the inner arm 33 is configured to drive the inner arm 33 to rotate relative to the air cart 10. The intermediate link 38 is configured to induce the outer arm 36 to rotate upon rotation of the inner arm 33 to automatically control a position of a distal end of the outer arm 36. For example, in certain embodiments, the position adjustment assembly 30 is configured to move the distal end of the outer arm 36 along a longitudinal axis 40, while maintaining the distal end at a substantially constant distance from the air cart 10 along a lateral axis 42. In this configuration, the position adjustment assembly 30 may align the guide tube 24 with each successive storage compartment opening 28.

In certain embodiments, the position adjustment assembly 30 includes a rotation control assembly 44 configured to induce the intermediate link 38 to drive the outer arm 36 to rotate upon rotation of the inner arm 33. For example, the rotation control assembly 44 may include a cam, and the intermediate link may include a follower configured to engage the cam. In such a configuration, contact between the cam and the follower drives the intermediate link 38 to move along the lateral axis 42 relative to the air cart 10 to facilitate rotation of the outer arm 36. For example, the cam may be shaped such that a lateral distance between the distal end of the outer arm 36 and the air cart 10 remains substantially constant as the distal end is driven to move along the longitudinal axis 40. In further embodiments, the outer arm 36 may include a height adjustment assembly configured to adjust a position of the product conveyor system 14 along a vertical axis 46 to facilitate alignment of the hopper 26 with the transporting vehicle, and/or to facilitate alignment of the guide tube 24 with the openings 28.

In order to control positioning and operation of the product conveyor system 14. The agricultural system 8 includes a controller 48. The controller 48 controls position of the product conveyor system 14 with the position adjustment assembly 30 through feedback from the alignment system 32. The alignment system 32 may include multiple sensors 50 that enable the controller 48 to determine the position of the guide tube 24 and the hopper 26 relative to the air cart 10 and a product source (e.g., end-dump truck or a belly-dump truck). The alignment system 32 may therefore include one or more sensors 50 placed at each of opening 28, 52 (e.g., outlets of the compartments 16 under the air cart 10); and/or on the hopper 26 and the guide tube 24.

In operation, the sensors 50 provide feedback regarding the position of the guide tube 24 relative to the openings 28 as well as the position of the hopper 26 relative to a product transport vehicle (i.e., product outlets on the product transport vehicle). In this way, the controller 48 determines the position and orientation of the product conveyor system 14 and is therefore able to control movement of the product conveyor system 14 with the position adjustment assembly 30 to move product from the product transport vehicle to one or more storage compartments 16 on the air cart 10. Likewise, when offloading unused product from the air cart 10 to a product transport vehicle or other location, the controller 48 uses alignment system 32 to place the hopper 26 below openings 52 located beneath one or more storage compartments 16 on the air cart 10 as well as placement of the guide tube 24 over a product transport vehicle (e.g., container on a vehicle).

The sensors 50 may be infrared, optical, magnetic, etc., or combinations thereof. In some embodiments, the sensors 50 may work in combination with emitters 54 that emit a signal that is detected by the sensors 50 enabling the controller 48 to control movement of the product conveyor system 14 with the position adjustment assembly 30 to align the emitter(s) 54 with and/or relative to the sensors(s) 50. The emitters 54 and sensors 50 may be placed in a variety of locations including proximate the openings 28, 52; in the storage compartment(s) 16; as well as on or within the product conveyor system 14 (e.g., hopper 26, guide tube 24, product transport tube 22). In some embodiments, the position adjustment assembly 30 may include sensors 50 (e.g., positioning sensors) that store predetermined positions of the position adjustment assembly 30 relative to the tank 16 in order to be properly positioned the product conveyer system 14. These position sensors may be integrated into actuators (e.g., hydraulic cylinders) that manipulate product conveyer system 14.

The controller 48 includes a processor 56 and a memory 58. For example, the processor 56 may be a microprocessor that executes software to control various actuators of the position adjustment assembly 30 in response to feedback from the alignment system 32 to maneuver and orient the product conveyor system 14. The processor 56 may include multiple microprocessors, one or more “general-purpose” microprocessors, one or more special-purpose microprocessors, and/or one or more application specific integrated circuits (ASICs), field-programmable gate arrays (FPGAs), or some combination thereof. For example, the processor 56 may include one or more reduced instruction set (RISC) processors.

The memory 58 may include a volatile memory, such as random access memory (RAM), and/or a nonvolatile memory, such as read-only memory (ROM). The memory 58 may store a variety of information and may be used for various purposes. For example, the memory 58 may store processor executable instructions, such as firmware or software, for the processor 56 to execute. The memory may include ROM, flash memory, a hard drive, or any other suitable optical, magnetic, or solid-state storage medium, or a combination thereof. The memory may store data, instructions, and any other suitable data. In operation, the processor 56 executes instructions on the memory 58 to control the product conveyor system 14 as well as the position adjustment assembly 30 to enable product movement to or from the storage container(s) 16.

In some embodiments, the automated fill system may include an opening system 60. The opening system 60 may include one or more lid sensors 62 and actuators 64 that control the opening and closing of the lids 66 over the openings 28. For example, the controller 48 may receive a signal from one or more fill sensors 68 on or in the storage container(s) 16. These fill sensors 68 detect how much product is in each storage container 16. In some embodiments, if there is only one storage container 16, the fill sensors 68 may emit a signal indicative of the amount of product in different sections of the storage container 16. These fill sensors 68 may be optical sensors, weight sensors, or combinations thereof. If the controller 48 detects that one or more storage containers 16 needs product, the controller 48 may activate the opening system 60 to open the desired lid or all of the lids 66 using their respective actuators 64. These actuators 64 may be hydraulic, pneumatic, electric, or a combination thereof. In some embodiments, the controller 48 may receive feedback from lid sensors 62 indicative of whether the lid(s) 66 is open or closed. If the lid(s) 66 is detected as being closed, the controller 48 controls the actuator(s) 64 to open the lid(s) 66. After filling the storage container(s), the controller 48 activates the opening system 60 to close the lids 66 with their respective actuator 64.

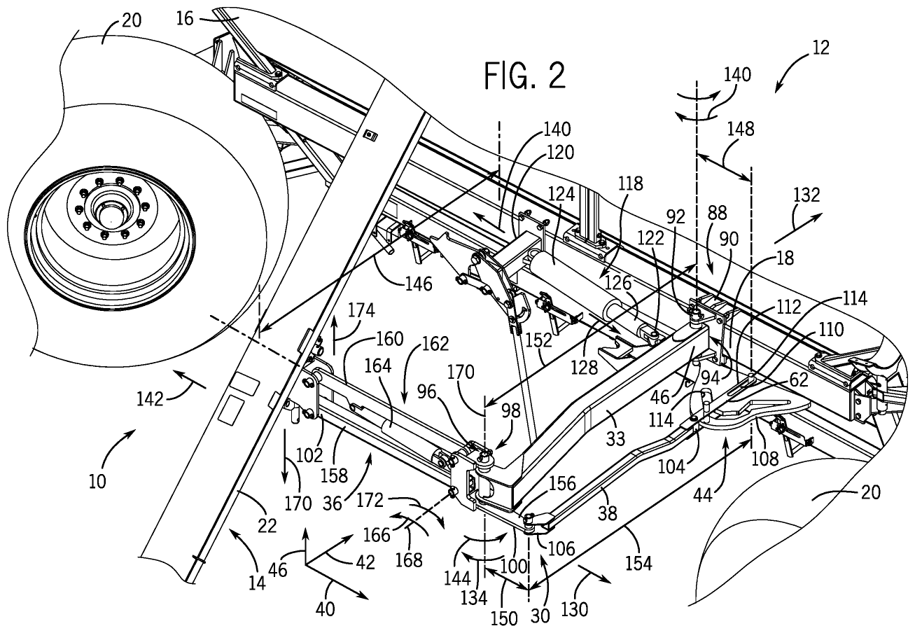

FIG. 2 is a detailed perspective view of an embodiment of a position adjustment assembly 30 that may be employed to adjust a position of the product conveyor system 14 relative to the air cart 10. As previously discussed, the position adjustment assembly 30 is configured to move and orient the product conveyor system 14 such that the guide tube 24 successively aligns with each storage compartment opening 28 and 52. As illustrated, a first end 88 of the inner arm 33 is rotatably coupled to the frame 18 of the air cart 10 at a first location 90. For example, in the illustrated embodiment, the position adjustment assembly 30 includes a mounting bracket 92 secured to the frame 18, and a pivot 94 configured to rotatably couple the first end 88 of the inner arm 33 to the mounting bracket 92. Furthermore, a second end 96 of the inner arm 33 is rotatably coupled to the outer arm 36 by a pivot 98. As illustrated, the pivot 98 is positioned between a first end 100 of the outer arm 36, and a second end 102 of the outer arm 36 (e.g., a subassembly that includes an intermediate knuckle with upper and lower parallel arms and a hydraulic cylinder). The transporting tube 22 of the product conveyor system 14 is rotatably coupled to the second end 102 of the outer arm 36 to facilitate adjustment of an orientation of the product conveyor system 14 relative to the air cart 10. In the illustrated embodiment, the product conveyor system 14 is supported by the inner arm 33 and the outer arm 36, i.e., the arms 33 and 36 are configured to transfer the vertical load of the product conveyor system 14 to the frame 18 of the air cart 10. The arms 33 and 36 are also configured to facilitate position adjustment of the product conveyor system 14 relative to the air cart 10.

In the illustrated embodiment, the intermediate link 38 extends between the rotation control assembly 44 and the first end 100 of the outer arm 36. Specifically, a first end 104 of the intermediate link 38 is engaged with the rotation control assembly 44, and a second end 106 of the intermediate link 38 is rotatably coupled to the first end 100 of the outer arm 36. As illustrated, the rotation control assembly 44 includes a cam 108, and the intermediate link 38 includes a follower 110. In this configuration, rotation of the inner arm 33 drives the follower 110 to move along the cam 108, thereby adjusting a lateral position of the first end 104 of the intermediate link 38. As a result, the intermediate link 38 drives the outer arm 36 to rotate about the pivot upon rotation of the inner arm 33. For example, the cam 108 may be shaped such that a lateral distance between the second end 102 of the outer arm 36 and the air cart 10 remains substantially constant as the inner arm 33 rotates. In the illustrated embodiment, the intermediate link 38 includes a slot 112 configured to engage a pin 114 of the rotation control assembly 44, thereby securing the intermediate link 38 to the rotation control assembly 44.

In the illustrated embodiment, the position adjustment assembly 30 includes a hydraulic cylinder 118 configured to rotate the inner arm 33 relative to the air cart 10. As illustrated, the hydraulic cylinder 118 includes a first end 120 rotatably coupled to the frame 18 of the air cart 10, and a second end 122 rotatably coupled to the inner arm 33. The hydraulic cylinder 118 includes a barrel 124, and a piston rod 126 configured to extend and retract relative to the barrel 124 to drive the inner arm 33 to rotate. While a hydraulic cylinder 118 is utilized in the illustrated embodiment, it should be appreciated that alternative linear actuators (e.g., screw drives, electromechanical actuators, etc.) may be employed in alternative embodiments. In further embodiments, a rotatory actuator (e.g., hydraulic, electrical, etc.) may be directly coupled to the pivot 94 to drive the inner arm 33 to rotate.

In the illustrated embodiment, extension of the piston rod 126 in the direction 128 drives the inner arm 33 to rotate in the direction 128. As the inner arm 33 rotates, the second end 96 of the inner arm 33 moves in the direction 130, thereby translating the product conveyor system 14 along the longitudinal axis 40 in the direction 130. In addition, movement of the second end 96 of the inner arm 33 induces the intermediate link 38 to move in the direction 132, thereby driving the follower 110 along the cam 108. Due to the shape of the cam 108, the first end 104 of the intermediate link 38 is driven to move along the lateral axis 42. For example, movement of the follower 110 away from the apex of the cam 108 induces the first end 104 of the intermediate link 38 to move in the direction 132. As discussed in detail below, movement of the intermediate link 38 in the direction 128 and movement of the end 102 of the outer arm 36 in the direction 132 induces the outer arm 36 to rotate about the pivot 98 in the direction 134. In this configuration, the cam 108 may be shaped such that a lateral distance 154 between the second end 102 of the outer arm 36 and the air cart 10 is precisely controlled. For example, the distance 154 may remain substantially constant as the inner arm 33 rotates in the direction 128. As a result, the product conveyor system 14 may be positioned to facilitate alignment of the guide tube 24 with each successive storage compartment opening 28 via adjustment of the hydraulic cylinder 118.

Conversely, retraction of the piston rod 126 in the direction 140 drives the inner arm 33 to rotate in the direction 140. As the inner arm 33 rotates, the second end 96 of the inner arm 33 moves in the direction 142, thereby translating the product conveyor system 14 along the longitudinal axis 40 in the direction 142. In addition, movement of the second end 96 of the inner arm 33 induces the intermediate link 38 to move, thereby driving the follower 110 along the cam 108. Due to the shape of the cam 108, the first end 104 of the intermediate link 38 is driven to move along the lateral axis 42. For example, movement of the follower 110 away from the apex of the cam 108 induces the first end 104 of the intermediate link 38 to move. As discussed in detail below, movement of the intermediate link 38 induces the outer arm 36 to rotate about the pivot 98 in the direction 144. In this configuration, the cam 108 may be shaped such that the lateral distance 146 between the second end 102 of the outer arm 36 and the air cart 10 is precisely controlled. For example, the distance 146 may remain substantially constant as the inner arm 33 rotates in the direction 144. As a result, the product conveyor system 14 may be positioned to facilitate alignment of the guide tube 24 with each successive storage compartment opening 28 via adjustment of the hydraulic cylinder 118 as the controller 48 receives feedback from the alignment system 32.

In alternative embodiments, the intermediate link 38 may be rotatably coupled directly to the frame 18 of the air cart 10, or to a support coupled to the mounting bracket 92. For example, in certain embodiments, the first end 104 of the intermediate link 38 is rotatably coupled to the air cart 10 at a second location, longitudinally offset from the first location 90 by a distance 148. In this configuration, the intermediate link 38 drives the outer arm 36 to rotate about the pivot 98 in a first direction (e.g., the direction 134) upon rotation of the inner arm 33 in a second direction (e.g., the direction 144), opposite the first direction, such that the lateral distance 146 between the second end 102 of the outer arm 36 and the air cart 10 remains substantially constant.

In the illustrated embodiment, the outer arm 36 is configured to adjust a height of the product conveyor system 14 relative to the air cart 10. As illustrated, the outer arm 36 includes a first member 158 extending between the first end 100 and the pivot 98. The outer arm 36 also includes a second member 160 rotatably coupled to the first member 158 adjacent to the pivot 98, and extending to the second end 102 of the outer arm 36. In the illustrated embodiment, the second member 160 is an element of a parallel linkage assembly 162 extending between the pivot 98 and the second end 102 of the outer arm 36. However, it should be appreciated that a single member may extend between the pivot 98 and the second end 102 in alternative embodiments. As illustrated, an actuator 164 is coupled to the parallel linkage assembly 162, and configured to adjust a height of the product conveyor system 14. For example, the actuator 164 may rotate the second member 160 in a downward direction 166 about an axis 168 substantially perpendicular to a rotational axis 170 of the pivot 98, thereby inducing the product conveyor system 14 to move in a downward direction 170 along the vertical axis 46. Conversely, the actuator 164 may rotate the second member 160 in an upward direction, thereby driving the product conveyor system 14 to move in an upward direction 174 along the vertical axis 46. In this manner, the height of the product conveyor system 14 may be particularly adjusted to facilitate alignment between the guide tube 24 and the storage compartment openings 28.

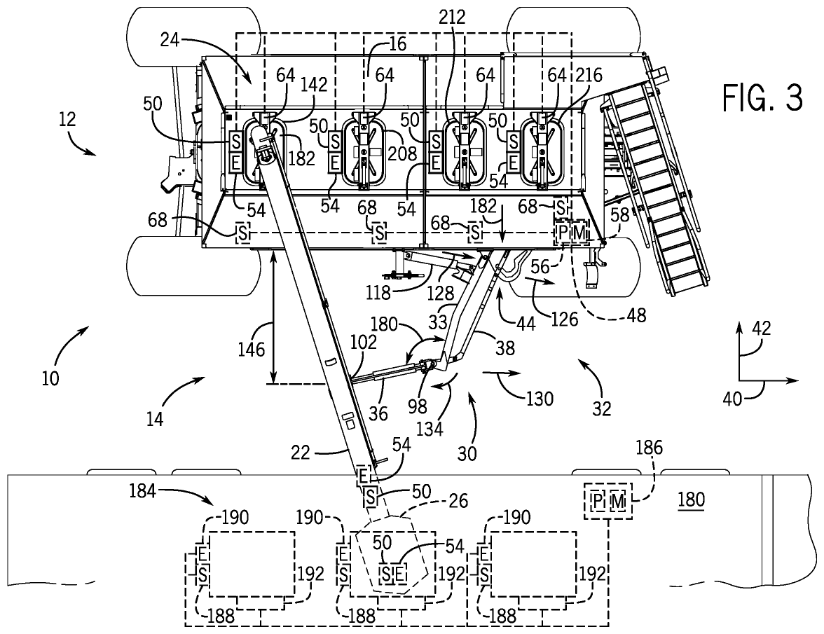

FIG. 3 is a top view of the position adjustment assembly 30, in which the product conveyor system 14 is aligned with a first storage compartment opening 182. As explained above, the controller 48 controls the position adjustment assembly 30 in response to feedback from the alignment system 32 in order to properly position the product conveyor system 14. For example, the alignment system 32 enables the controller 48 to position the guide tube 24 above the opening 182 and the hopper 26 below openings 184 in the truck 180 when conveying product from the truck 180 to the storage tank(s) 16. Likewise, the alignment system 32 enables the controller 48 to position the hopper 26 below openings 52 in the storage tank(s) 16 while placing the guide tube 24 in position above the truck 180.

In some embodiments, the truck 180 may include a controller 186 that communicates with the controller 48 on the air cart 10 to facilitate alignment of the hopper 26 and guide tube 24 relative to the truck 180. For example, the controller 186 may control one or more sensors 188 and/or emitters 190 to facilitate alignment of the hopper 26 and guide tube 24 relative to openings 184 on the truck 180. The controller 186 may also control one or more actuators 192 that open and close the openings 184 (e.g. outlets) in the truck 180 (e.g., open valves, lids). For example, once the hopper 26 is positioned beneath one of the openings 184, the controller 186 receives a signal from the controller 48 to open one or more openings 184 on the truck 180. The controller 186 then sends a signal to the actuator 192 that opens that particular opening 184 to release product from the truck 180 (i.e., storage container on the truck 180) into the hopper 26. In some embodiments, the truck 180 may not include a controller 186 and instead the controller 48 may communicate directly with and control operation of the actuators 192. In some embodiments, the controller 186 may also control movement of the truck 180 (e.g., control the engine to move the truck 180) to align the hopper 26 with the openings/outlets 184 on the truck 180.

In order to position the product conveyor system 14, the controller 48 controls the hydraulic cylinder 118 in order to place the hydraulic cylinder 118 in a substantially retracted position, thereby establishing an angle 180 between the inner arm 33 and the outer arm 36. Due to the geometry of the position adjustment assembly components, the second end 102 of the outer arm 36 is positioned to facilitate alignment of the product conveyor system 14 with a first storage compartment opening 182. In addition, the hopper 26 is aligned with one of the openings 184 of the truck 178. Consequently, product may flow from the openings 184 to the hopper 26, through the transporting tube 22, and through the first storage compartment opening 182.

Once a desired quantity of product has been delivered to the first storage compartment using feedback from the fill sensors 68, the product conveyor system 14 may be aligned with a successive storage compartment opening. For example, extension of the hydraulic cylinder 118 in the direction 128 drives the inner arm 33 to rotate. As the inner arm 33 rotates, the outer arm 36, the product conveyor system 14 and the intermediate link 38 are driven in the direction 130. Due to the shape of the rotation control assembly 44, movement of the intermediate link 38 in the direction 130 induces lateral movement of the intermediate link 38 in the direction 42, thereby driving the outer arm 36 to rotate about the pivot 98 in the direction 134. As a result, a distance 146 between the second end 102 of the outer arm 36 and the air cart 10 remains substantially constant as the inner arm 33. Consequently, the product conveyor system 14 may be translated in the direction 130 while maintaining a desired distance from the air cart 10, thereby facilitating alignment of the product conveyor system 14 with a successive storage compartment opening.

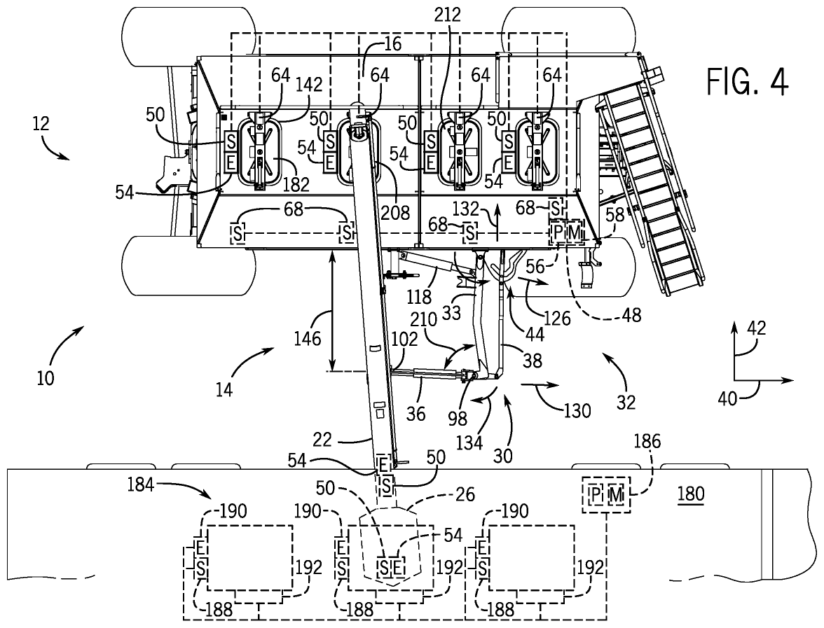

FIG. 4 is a top view of the position adjustment assembly 30, in which the product conveyor system 14 is aligned with a second storage compartment opening 208. As illustrated, the hydraulic cylinder 118 is extended relative to the position shown in FIG. 3, thereby moving the inner arm 33 in the direction 130, and establishing an angle 210 between the inner arm 33 and the outer arm 36. In the illustrated embodiment, the angle 210 is less than the angle 180 shown in FIG. 3. As a result, the second end 102 of the outer arm 36 is positioned to facilitate alignment of the product conveyor system 14 with a second storage compartment opening 208. In addition, the hopper 26 remains aligned with an opening 184 of the truck 180. Consequently, product may flow from the truck outlet to the hopper 26, through the transporting tube 22, and into the second storage compartment opening 208. Once a desired quantity of product has been delivered to the second storage compartment using feedback from one or more fill sensors 68, the controller 48 controls the hydraulic cylinder 118 to align the product conveyor system 14 with a successive storage compartment opening.

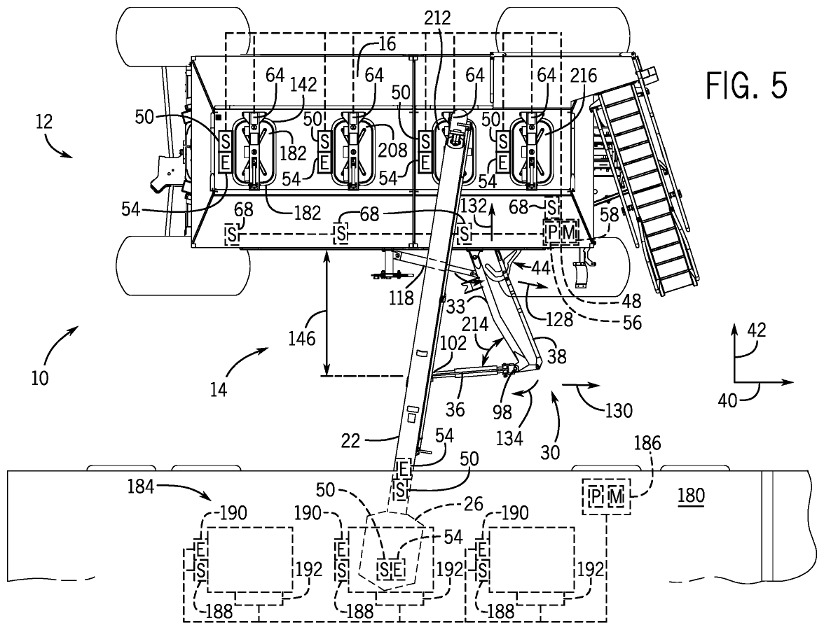

FIG. 5 is a top view of the position adjustment assembly 30, in which the product conveyor system 14 is aligned with a third storage compartment opening 212. As illustrated, the hydraulic cylinder 118 is extended relative to the position shown in FIG. 4, thereby moving the inner arm 33 in the direction 130, and establishing an angle 214 between the inner arm 33 and the outer arm 36. In the illustrated embodiment, the angle 214 is less than the angle 210 shown in FIG. 4. As a result, the second end 102 of the outer arm 36 is positioned to facilitate alignment of the product conveyor system 14 with a third storage compartment opening 212. In addition, the hopper 26 remains aligned with an outlet of the truck 180. Consequently, product may flow from the truck outlet to the hopper 26, through the transporting tube 22, and into the third storage compartment opening 212. Once a desired quantity of product has been delivered to the third storage compartment using feedback from one or more fill sensors 68, the controller 48 controls the hydraulic cylinder 118 to align the product conveyor system 14 with a successive storage compartment opening.

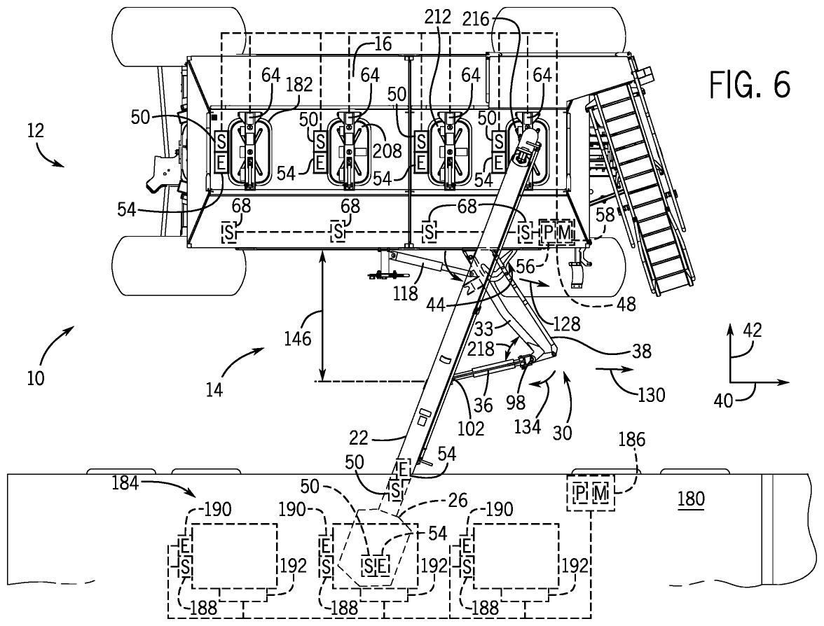

FIG. 6 is a top view of the position adjustment assembly 30, in which the product conveyor system 14 is aligned with a fourth storage compartment opening 216. As illustrated, the hydraulic cylinder 118 is extended relative to the position shown in FIG. 5, thereby moving the inner arm 33 in the direction 130, and establishing an angle 218 between the inner arm 33 and the outer arm 36. In the illustrated embodiment, the angle 218 is less than the angle 214 shown in FIG. 5. As a result, the second end 102 of the outer arm 36 is positioned to facilitate alignment of the product conveyor system 14 with a fourth storage compartment opening 216. In addition, the hopper 26 remains aligned with an opening 184 of the truck 180. Consequently, product may flow from the truck outlet to the hopper 26, through the transporting tube 22, and into the fourth storage compartment opening 216.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An agricultural system, comprising:
a first storage tank configured to receive and store product, the first storage tank comprising a first lid that opens and closes a first aperture in the first storage tank;
an automated fill system configured to deliver product to or remove product from the first storage tank automatically, the automated fill system comprising:
a product conveyor system configured to transfer the product, the product conveyor system comprises:
a hopper configured to receive product from a second storage tank;
a conveyor coupled to the hopper and configured to convey the product away from the hopper to a discharge opening;
an alignment system, wherein the alignment system is configured to align the discharge opening with the first aperture in the first storage tank;
an opening system configured to automatically open the first lid to the first storage tank, the opening system comprising:
a first actuator coupled to the first lid and configured to open and close the first lid; and
a controller configured to control the alignment system and the opening system to control transfer of the product from the second storage tank to the first storage tank.

2. The system of claim 1, wherein the opening system comprises a second actuator coupled to the second storage tank, and wherein the controller is configured to control the second actuator to open and close the second storage tank.

3. The system of claim 1, wherein the alignment system comprises a first sensor configured to emit a first signal indicative of a position of the discharge opening relative to the first aperture, wherein the controller is configured to receive the first signal from the first sensor and control movement of the discharge opening to align the discharge opening with the first aperture.

4. The system of claim 2, comprising a second sensor configured to emit a second signal indicative of a position of the first lid, wherein the controller is configured to receive the second signal and control the second actuator in response to the second signal.

5. The system of claim 2, comprising a third sensor within the first storage tank, wherein the third sensor is configured to emit a third signal indicative of an amount of product within the first storage tank, and wherein the controller couples to the third sensor and controls the second actuator in response to feedback from the third sensor.

6. The system of claim 5, wherein the third sensor is an optical sensor, an infrared sensor, a weight sensor, or a combination thereof.

7. The system of claim 2, comprising a fourth sensor coupled to the product conveyer system, wherein the fourth sensor is configured to emit a fourth signal indicative of an amount of product flowing through the product conveyer system, and wherein the controller couples to the fourth sensor and controls the second actuator in response to feedback from the fourth sensor.

8. The system of claim 7, wherein the fourth sensor is an optical sensor, an infrared sensor, a mass flow sensor, or a combination thereof.

9. The system of claim 1, wherein the alignment system comprises a fifth sensor configured to emit a fifth signal indicative of a position of the hopper relative to a second aperture, wherein the controller is configured to receive the fifth signal from the fifth sensor and control movement of the discharge opening to align the discharge opening with the second aperture.

10. An agricultural system, comprising:
an automated fill system configured to deliver product to or remove product from a first storage tank automatically, the automated fill system comprising:
a product conveyor system configured to transfer the product;
an alignment system, wherein the alignment system is configured to align the product conveyer system to deliver or remove the product from the first storage tank; and
a controller configured to control the alignment system to control transfer of the product to and from the first storage tank.

11. The system of claim 10, comprising an opening system configured to automatically open and close an aperture of the first storage tank with a lid coupled to a first actuator.

12. The system of claim 11, wherein the opening system comprises a first sensor configured to emit a first signal indicative of a position of the lid, wherein the controller is configured to receive the first signal and control the first actuator in response to the first signal.

13. The system of claim 10, wherein the product conveyer system comprises a hopper configured to receive product, a conveyer coupled to the hopper and configured to convey the product away from the hopper, and a spout coupled to the conveyer and configured to discharge the product driven by the conveyer.

14. The system of claim 12, wherein the alignment system comprises a second sensor configured to emit a second signal indicative of the position of a spout relative to the first storage tank, wherein the controller is configured to receive the second signal from the second sensor and control movement of the product conveyer system to align the spout with the first storage tank.

15. The system of claim 10, comprising a third sensor, wherein the third sensor is configured to emit a third signal indicative of an amount of product within the first storage tank, and wherein the controller couples to the third sensor and controls the product conveyer system in response to feedback from the third sensor.

16. The system of claim 15, wherein the third sensor is an optical sensor, an infrared sensor, a weight sensor, or a combination thereof.

17. An agricultural system, comprising:
a first storage tank configured to receive and store product, the first storage tank comprising a first lid that opens and closes a first aperture in the first storage tank;
an automated fill system configured to deliver product to or remove product from the first storage tank automatically, the automated fill system comprising:
a product conveyor system configured to transfer the product, the product conveyer system comprising:
a hopper configured to receive product from a second storage tank;
a conveyer coupled to the hopper and configured to convey the product away from the hopper to a discharge opening; and
an alignment system, wherein the alignment system is configured to align the discharge opening with the first aperture in the first storage tank.

18. The agricultural system of claim 17, comprising an opening system configured to automatically open the first lid to the first storage tank.

19. The agricultural system of claim 18, comprising a controller configured to control the alignment system and the opening system to control transfer of the product from the second storage tank to the first storage tank.

20. The agricultural system of claim 19, wherein the alignment system comprises a first sensor configured to emit a first signal indicative of a position of the discharge opening relative to the first aperture, wherein the controller is configured to receive the first signal from the first sensor and control movement of the discharge opening to align the discharge opening with the first aperture.
